(19) United States
(12) Patent Application Publication
(10) Pub. No.: US 2003/0153224 A1
(43) Pub. Date: Aug. 14, 2003

(54) Light-protective textile

(76) Inventors: Robert Groten, Sundhoffen (FR); Linda Mooshian, Haverhill, MA (US); Georges Riboulet, Colmar (FR)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/220,907

(22) PCT Filed: Mar. 2, 2001
(86) PCT No.: PCT/EP01/02357

(30) Foreign Application Priority Data
Mar. 7, 2000 (DE) 100 11 053.3

(51) Int. Cl. B32B 9/00; D04H 3/00

(52) U.S. Cl. 442/59; 442/327; 442/400

(57) ABSTRACT

The present invention relates to a textile light-protective material composed of a microfilament non-woven fabric having a mass per unit area of 20 to 300 g/m², in which the non-woven fabric is made of melt-spun and drawn multicomponent continuous filaments having a titer of 1.5 to 5 dtex that are deposited immediately to form a non-woven material and at least 80 % of the multicomponent continuous filaments, after an optional pre-bonding, are split to form continuous microfilaments having a titer of 0.05 to 2.0 dtex and are bonded.

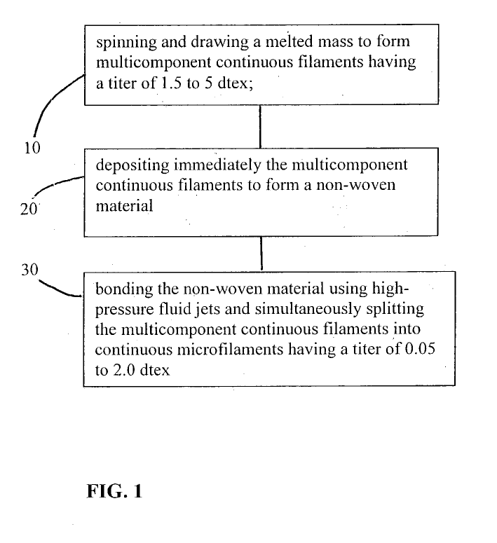

### DESCRIPTION

The present invention relates to a textile light-protective material for windows, composed of a microfilament non-woven fabric having a mass per unit area of 20 to 300 g/m².

Camouflage and light-protective devices for windows are provided in a variety of specific embodiments. In principle, the distinction should be made between soft and hard materials for this purpose. Curtains, drapes, or roller blinds are made of soft textile materials, and vertical or horizontal jalousies and pleated blinds are made of hard materials. Appropriate textile light-protective devices are also used for screening excessive light radiation, for example, in winter gardens. From the document, U.S. Pat. No. 5,436,064, stiff textile composites are known which are made of a non-woven fabric composed of thermoplastic material and a woven fabric that is assembled, stitched, and fused together by heating. Furthermore, from the document, U.S. Pat. No. 5,600,974, stiff textile composites are known which are made of non-woven fabrics that are embroidered using yarn in a weaving frame. In this context, the non-woven fabric is made of two different fibers, of which one is thermoplastic and is melted on after the yarn embroidery. The known textile composites can also be provided with a foamed plastic layer and are suitable for manufacturing vertical jalousies, pleated blinds, wall panels, or automobile interior coverings.

The known textile light-protective materials have disadvantages with regard to the high use of material, insufficient screening of the impinging light especially in the UV range, or their resistance to light. In addition, a rational manufacturing method is desirable.

The present invention has the objective of indicating a textile light-protective material as well as a method for manufacturing it.

According to the present invention, the objective is achieved by a textile light-protective material that is made of a microfilament non-woven fabric having a mass per unit area of 20 to 300 g/m²,the non-woven fabric being composed of melt-spun and drawn multicomponent continuous filaments having a titer of 1.5 to 5 dtex that are deposited immediately to form a non-woven material, and at least 80% of the multicomponent continuous filaments are, after an optional pre-bonding, split to form continuous microfilaments having a titer of 0.05 to 2.0 dtex and are bonded. The isotropic fiber distribution in the non-woven fabric makes it unnecessary to hem it and to take into account the machine running direction. As a result of the continuous filaments, the textile light-productive material has no unraveled fibers. A chemical finishing is not necessary.

The textile light-protective material is advantageously one in which the non-woven fabric having a mass per unit area of 20 to 300 g/m² is made of melt-spun and aerodynamically drawn multicomponent continuous filaments having a titer of 1.5 to 3 dtex that have been immediately deposited to form a non-woven material, and at least 80% of the multicomponent continuous filaments are split to form continuous microfilaments having a titer of 0.1 to 1.0 dtex and are bonded.

The textile light-protective material is advantageously one in which the multicomponent continuous filament is a bicomponent continuous filament made of two incompatible polymers, specifically a polyester and a polyamide. A bicomponent continuous filament of this type has a good capacity for splitting into continuous microfilaments, and it produces a favorable ratio of strength to mass per unit area. At the same time, the textile light-protective material according to the present invention, due to the polymers that are used and their filament structure, is wrinkle-free, easily washable, and fast drying, i.e., easy to maintain.

The textile light-protective material is advantageously one in which the multicomponent continuous filaments have a cross section marked by an orange-like multisegment structure, also termed “pie,” each segment in alternating fashion containing one of the two incompatible polymers. In addition to this orange-like multi-segment structure of the multicomponent continuous filaments, a “side-by-side” (s/s) segment arrangement of the incompatible polymers in the multicomponent continuous filament is also possible, which is advantageously used for producing crimped filaments. Segment arrangements of this type of the incompatible polymers in the multicomponent continuous filament have proven to be easy to split. The textile light-protective material has a very favorable ratio of mass per unit area to UV-light absorption capacity, so that highly effective light-protective materials can be manufactured therefrom even when small amounts of material are used.

The textile light-protective material is also advantageously one in which at least one of the incompatible polymers forming the multicomponent continuous filament contains an additive, such as coloring pigments and/or permanently acting antistatic agents, in quantities up to 10% wt. As a result of the additives, static charges can be reduced or avoided. The textile light-protective material, in particular when used as curtains or drapes, has excellent maintenance properties with regard to its excellent washability and short drying times.

The method according to the present invention for manufacturing a textile light-protective material is seen in that multicomponent continuous filaments are spun from the melted mass, are drawn, and are deposited immediately to form a non-woven material, a pre-bonding is carried out, and the non-woven fabric is bonded by high-pressure fluid jets as it is simultaneously split into continuous microfilaments having a titer of 0.05 to 2.0 dtex. The textile light-protective material that is obtained in this manner is very uniform with regard to its thickness, has an isotropic fiber distribution, has no tendency to delaminate, and is marked by high modular values.

The method for manufacturing the textile light-protective material is advantageously carried out such that the bonding and the splitting of the multicomponent continuous filaments is accomplished by subjecting the non-woven fabric, which has been optionally pre-bonded, to high-pressure water jets at least once on each side. As a result, the textile light-protective material has an excellent surface and a degree of splitting of the multicomponent continuous filaments that is greater than 80%.

The textile light-protective material according to the present invention is also advantageously subjected to a point calendering to increase its wear resistance. For this purpose, the split and bonded non-woven fabric is conveyed through heated rollers, of which at least one roller has elevations, which result in a pointwise melting of the filaments to each other.

The textile light-protective material, due to its excellent haptic properties, is used for manufacturing curtains, drapes, or rolling blinds. In this context, in the water-jet bonding of the multifilament non-woven fabric, it is possible to carry out a surface patterning, or pattern forming, through the selection of the substrate.

The textile light-protective material is also advantageously used for manufacturing vertical jalousies or pleated blinds, it being possible to increase the stiffness of the material by a stamp-calendering, by the fusing-on of a polymer component, and/or by coating using a foamed plastic.

### EXAMPLE 1

From an s/s polyester-polyamide (PES-PA6.6) bicomponent continuous filament having a weight ratio of PES to PA6.6 of 60:40, a fiber web having a mass per unit area of 134 g/m² is produced and is subjected to a water-jet needling on both sides at pressures up to 230 bar. The bicomponent continuous filaments, after the water-jet needling, which results in a simultaneous splitting of the initial fibers, have a titer <1.5 dtex and a thickness of 0.51 mm. For the tear resistance, 372 N were measured in the machine running direction, and 331 N were measured in the transverse direction. After irradiation on a black wall using a xenon test lamp 150 S at a light energy of 152 W/m² over 150 hours at a relative humidity of 45% and a temperature of 90 degrees C., the change was ascertained through a comparison using 6 blue tones. The sample was evaluated as >7 on a scale extending from 4 to 7.

### EXAMPLE 2

From a 16-segment (PIE) polyester-polyamide (PES-PA6.6) bicomponent continuous filament having a weight ratio of PES to PA6.6 of 70:30, a fiber web having a mass per unit area of 116 g/m² is produced and is subjected to a water-jet needling on both sides at pressures up to 230 bar. The bicomponent continuous filaments, after the water-jet needling, which results in a simultaneous splitting of the initial fibers, have a titer <0.1 dtex and a thickness of 0.51 mm. For the tear resistance, 383 N were measured in the machine running direction, and 324 N were measured in the transverse direction. After irradiation on a black wall using a xenon test lamp 150 S at a light energy of 152 W/m² over 150 hours at a relative humidity of 45% and a temperature of 90 degrees C, the change was ascertained through a comparison using 6 blue tones. The sample was evaluated as >7 on a scale extending from 4 to 7.

| Example 3 | |
|---|---|
| (OP-370) | 7 |
| Example 4 | |
| (OP-465) | ≧7 |
| Example 5 | |
| (OP-464) | 7 |
| Example 6 | |
| (OP-690) | 7 |

### EXAMPLE 7

From a polyethylene terephthalate polyamide (PET-PA) bicomponent continuous filament having a weight ratio of PET/PA66 in the elementary fiber of 70/30 and an additive of X% wt of titanium dioxide, a fiber web having a mass per unit area of 80 g/m² is produced and is subjected to a water-jet needling on both sides at pressures up to 230 bar. The bicomponent continuous filaments, after the water-jet needling, which results in a simultaneous splitting of the initial fibers, have a titer of 0.1 to 0.8 dtex. The textile light-protective material has UV protection of 50+, as determined in accordance with the Australian-New Zealand Standard AS/NZS 4399:1996. In this context, the transmission is measured in percent in a range from 250 to 450 nm.

1. A textile light-protective material comprising a microfilament non-woven fabric having a mass per unit area of 20 to 300 g/m², the non-woven fabric being composed of multicomponent continuous filaments having a titer of 1.5 to 5 dtex that are melt-spun, drawn, and deposited immediately to form a non-woven material, and at least 80% of the multicomponent continuous filaments, after an optional pre-bonding, are split to form continuous microfilaments having a titer of 0.05 to 2.0 dtex and are bonded.

2. The textile light-protective material as recited in claim 1,
wherein the non-woven fabric having a mass per unit area of 35 to 200 g/m² is made of melt-spun and aerodynamically drawn multicomponent continuous filaments having a titer of 1.5 to 3 dtex, that are deposited immediately to form a non-woven material, and at least 80% of the multicomponent continuous filaments, after an optional pre-bonding, are split to form continuous microfilaments having a titer of 0.1 to 1.0 dtex and are bonded.

3. The textile light-protective material as recited in claim 1 or 2,
wherein the multicomponent continuous filament, a bicomponent continuous filament, is made up of two incompatible polymers, specifically a polyester and a polyamide.

4. The textile light-protective material as recited in one of claims 1 through 3,
wherein the multicomponent continuous filaments have a cross section of an orange-like multisegment structure, each segment in alternating fashion containing one of the two incompatible polymers and/or possessing a “side-by-side” structure.

5. The textile light-protective material as recited in one of claims 1 through 4,
wherein at least one of the incompatible polymers forming the multicomponent continuous filament contains an additive, such as a coloring pigment, a permanently acting antistatic agent, and/or additives that influence the hydrophilic or hydrophobic properties, in quantities up to 10% wt.

6. A method for manufacturing a textile light-protective material as recited in one of claims 1 through 5,
wherein multicomponent continuous filaments are spun from the melted mass, are drawn, and are deposited immediately to form a non-woven material, an optional pre-bonding is carried out, and the non-woven fabric is bonded using high-pressure fluid jets and is simultaneously split into continuous microfilaments having a titer of 0.05 to 2.0 dtex.

7. The method as recited in claim 6,
wherein the multicomponent continuous filaments are bonded and split by subjecting the non-woven fabric, which is optionally pre-bonded, to high-pressure fluid jets at least once on each side.

8. The method as recited in claim 6 or 7,
wherein the dyeing of the multicomponent continuous filaments is undertaken by spin dyeing.

9. The method as recited in one of claims 6 through 8,
wherein the textile light-protective material is point calendered.

10. The textile light-protective material as recited in one of claims 1 through 9,
wherein it is used for manufacturing curtains, drapes, or rolling blinds.

11. The textile light-protective material as recited in one of claims 1 through 9,
wherein it is used for manufacturing vertical jalousies or pleated blinds.
